(19) United States
(12) Patent Application Publication
(10) Pub. No.: US 2015/0369647 A1
(43) Pub. Date: Dec. 24, 2015

(54) Method and Apparatus for Metering in Liquid Distribution System

(71) Applicant: Rockwater Energy Solutions, Houston, TX (US)

(72) Inventors: Biren Kumar, Sugar Land, TX (US); Don Reilly, Houston, TX (US)

(21) Appl. No.: 14/823,688

(22) Filed: Aug. 11, 2015

Related U.S. Application Data
(63) Continuation-in-part of application No. 14/620,754, filed on Feb. 12, 2015.
(60) Provisional application No. 61/940,080, filed on Feb. 14, 2014.

(51) Int. Cl. G01F 23/284; G01F 23/296

(52) U.S. Cl. CPC G01F 23/284; G01F 23/296

(57) ABSTRACT

A system for measuring the amount of liquid dispensed from a container includes a satellite or wireless uplink to a billing system. The system measures the liquid dispensed from a container using a distance sensor such as an ultrasonic, sonar, or radar transducer. The system may include a display and/or printer capable of outputting liquid usage data or tickets, invoices, or receipts. The system may be included on a flatbed truck used to deliver or retrieve the container.

### CROSS-REFERENCE TO RELATED APPLICATIONS

This application is a continuation-in part application which claims priority from priority from U.S. non-provisional application No. 14/620,754, filed Feb. 12, 2015 which claims priority from U.S. provisional application No. 61/940,080, filed Feb. 14, 2014, which is incorporated by reference herein in its entirety.

### TECHNICAL FIELD

1. Field of the Disclosure

The present disclosure relates in general to the distribution of liquids, and specifically to measurement of liquid dispensed from a container.

2. Background of the Disclosure

In the oilfield industry, a variety of liquids may be utilized during many operations used in drilling, completing, and producing a well. For example, liquid used during hydraulic fracturing operations may include a variety of chemicals used to, for example, reduce friction, reduce surface effects, or otherwise affect the downhole formation during a fracturing process. Suppliers of these liquids may utilize Intermediate Bulk Containers to transport liquids to and between wellsites. Liquids are generally sold by volume used, and a given wellsite may only use a portion of the liquid supplied. Typically, volume used must be determined on site by direct measurement of fluid levels in the containers.

### SUMMARY

The present disclosure provides for a system for determining the amount of liquid dispensed from a fluid container. The system may include a fluid container, the fluid container at least partially filled with a liquid, the remainder of the interior of the fluid container filled with a gas. The fluid container may include at least one drain outlet positioned to allow the liquid to be dispensed from the fluid container. The fluid container may include a pressure transducer positioned to measure the differential pressure between the gas or the liquid and the surrounding environment. The system may include a control unit positioned to receive a differential pressure signal from the pressure transducer and positioned to calculate the volume of liquid dispensed.

The present disclosure also provides for a method of measuring a volume of a liquid dispensed. The method may include filling, at least partially, a fluid container with a liquid, the remainder of the interior of the fluid container filled with a gas, the fluid container including at least one drain outlet positioned to allow the liquid to be dispensed from the fluid container, the fluid container including a pressure transducer positioned to measure the differential pressure between the gas or the liquid and the surrounding environment; reading the differential pressure from the pressure transducer to determine an initial pressure; dispensing at least a portion of the liquid from the fluid container; reading the differential pressure from the pressure transducer to determine a second pressure; calculating the volume of liquid dispensed.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a liquid delivery and accounting system consistent with embodiments of the present disclosure.

FIGS. 2, 3 depict a cross section view of a fluid container consistent with embodiments of the present disclosure.

FIG. 4 depicts a cross section view of a fluid container consistent with embodiments of the present disclosure.

FIG. 5 depicts a cross section view of a fluid container consistent with embodiments of the present disclosure.

FIG. 6 depicts a cross section view of a fluid container consistent with embodiments of the present disclosure.

FIG. 7 depicts a cross section view of a fluid container consistent with embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

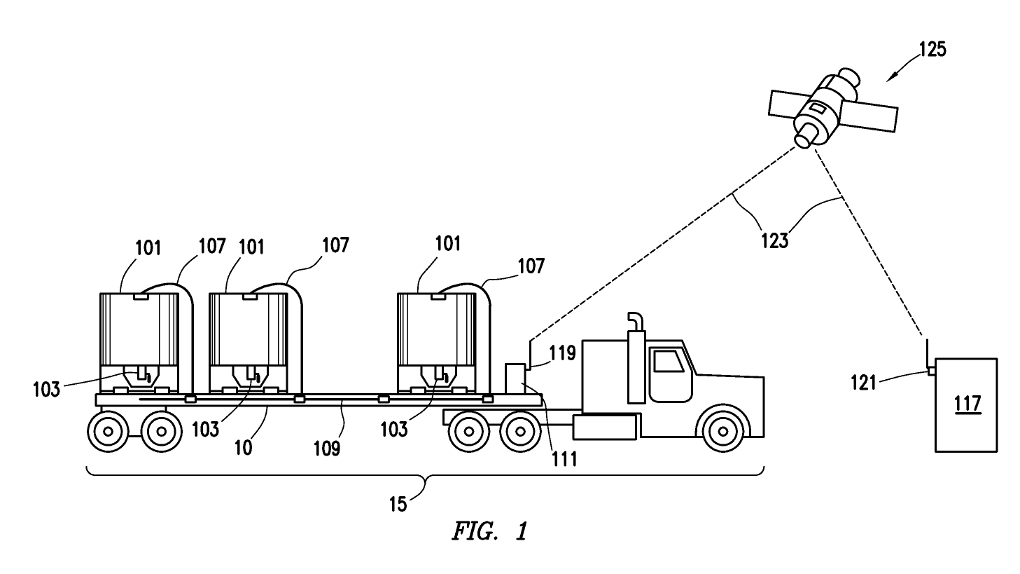

FIG. 1 depicts a liquid delivery system consistent with embodiments of the present disclosure. FIG. 1 depicts fluid containers 101 positioned on flatbed 10 of truck 15. Truck 15 may be used to, for example, deliver fluid containers 101 to a wellsite, return fluid containers 101 from the wellsite, or transfer fluid containers 101 between wellsites. Each of fluid containers 101 is at least partially filled with a liquid to be transferred. Fluid containers 101 include at least one drain 103 positioned to allow liquid to be drawn from the fluid container 101 to be used at the wellsite. In some embodiments, fluid containers 101 may be filled at a supply depot. In some embodiments, a flow meter may be attached to drain 103 (not shown) to determine the amount of fluid exiting drain 103. At the supply depot, fluid containers 101 may be at least partially filled with the desired liquid. In certain other embodiments, fluid container 101 may be a tank truck, ISO container, frac tank, multi-compartment tank, or any other container capable of containing liquid.

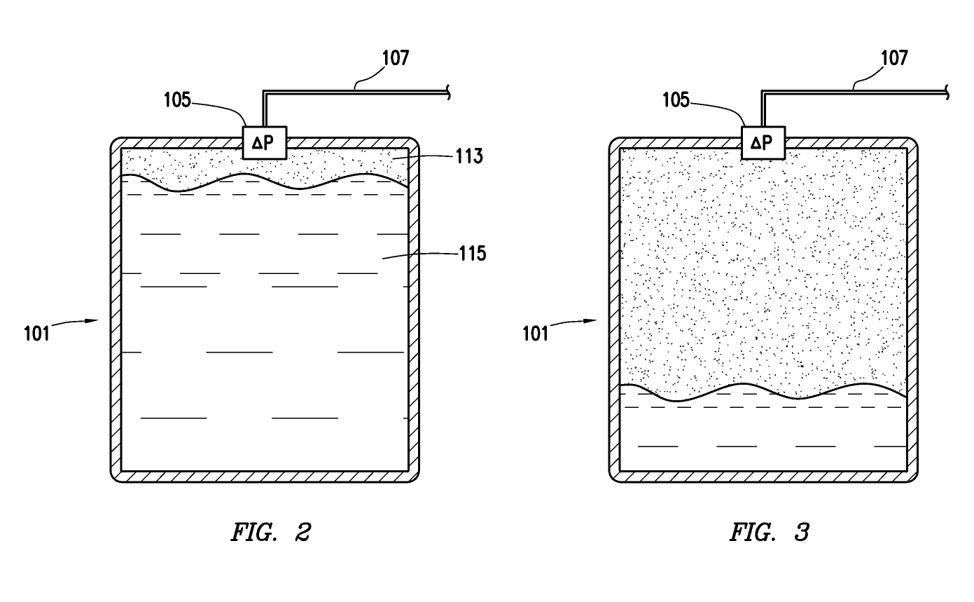

As depicted in FIGS. 2, 3, fluid container 101 may include differential pressure sensor 105 positioned to measure the differential pressure between the inside of fluid container 101 and the external environment. Differential pressure sensor 105 may be positioned in an existing aperture at the top of fluid container 101, such as a bung hole. Differential pressure sensor 105 may output the differential pressure as an electrical signal via sensor wire 107. As depicted in FIG. 1, sensor wire 107 may, when fluid container 101 is positioned on flatbed 10, a tank truck, ISO container, frac tank, or multi-compartment tank, electrically connect to sensor bus 109. Sensor bus 109 may serve to connect each fluid container 101 with control unit 111. Sensor bus 109 may be positioned to run along the side of flatbed 10 to, for example, prevent a potential tripping hazard for one walking on flatbed 10.

Control unit 111 may be positioned to measure the differential pressure as output by each fluid container 101, allowing control unit 111 to calculate the volume of liquid remaining in each fluid container 101. In some embodiments, flatbed 10 may include a suspension system positioned to ensure any fluid containers 101 are level at the time of reading. In some embodiments, the suspension system may be an active suspension including, for example and without limitation, an air suspension system.

In some embodiments, control unit 111 may include a display to display relevant data to a user including, for example and without limitation, starting liquid volume, current liquid volume, change in liquid volume, time of delivery, time of current and previous measurement, etc. In some embodiments, control unit 111 may include a printer to print, for example, a ticket, invoice, or receipt for the liquid used. In some embodiments, control unit 111 may output or print readings or measurements on demand and/or according to a schedule. In some embodiments, control unit 111 may include a data port capable of being connected to a wellsite network. In some embodiments, the data port may be, as understood in the art, an RS 232 compatible connection.

In some embodiments, control unit 111 may be powered by a battery. In some embodiments, the battery may be recharged by a solar array. In some embodiments, the battery may be recharged by a wind turbine. In some embodiments, control unit 111 may also be capable of providing a closed pressure system. In some such embodiments, control unit 111 may be positioned to control a pump or to control a valve on a compressed gas container each positioned to provide pressurized gas to fluid container 101 to, for example, fill space in fluid container 101 left by dispensed fluid or to force fluid from fluid container 101.

In some embodiments, the combined gas law may be utilized to determine the amount of liquid that has been dispensed since the last time fluid container 101 was connected to control unit 111 by measuring, as depicted in FIGS. 2, 3, the change in pressure of gas 113 positioned within fluid container 101 as liquid 115 is dispensed. As understood in the art, the combined gas law may be approximated as follows:

$$\frac{{P}_{1} \times {V}_{1}}{{T}_{1}} = k ,$$

where P₁ is the pressure of gas 113, V₁ is the volume of the gas, T₁ is the temperature of the gas, and k is a constant. The constant k remains the same value while conditions, such as pressure, volume, and temperature vary. Thus, extending the combined gas law to apply to a second set of parameters, the following equations may be derived:

$$\frac{{P}_{1} \times {V}_{1}}{{T}_{1}} = \frac{{P}_{2} \times {V}_{2}}{{T}_{2}} , and$$

$${V}_{2} = \frac{{P}_{1}}{{P}_{2}} \cdot \frac{{T}_{2}}{{T}_{1}} \cdot {V}_{1} ,$$

where P₂, V₂, and T₂ are the pressure, volume, and temperature of gas 113 at the second point in time.

Assuming that fluid container 101 is sealed at the time it is filled by the supply depot and no additional gas may enter thereinto, by measuring the change in pressure of gas 113 between the filled state and the at least partially emptied state (as well as the temperature change), the corresponding volume of liquid 115 dispensed may be calculated. The equation to do so may be derived as follows:

$${V}_{container} = {V}_{gas} + {V}_{fluid}$$

$$Δ {V}_{gas} + Δ {V}_{fluid} = 0$$

$$Δ {V}_{fluid} = - Δ {V}_{gas .} = ( {V}_{container} - {V}_{fluid . filled} ) ( \frac{{P}_{filled}}{{P}_{emptied}} \cdot \frac{{T}_{emptied}}{{T}_{filled}} - 1 )$$

where V_{container} is the volume of the container, ΔV_{gas} and ΔV_{fluid} are the change in volume of the gas and liquid respectively, V_{liquidfilled} is the volume of liquid in fluid container 101 when fluid container 101 is delivered to the wellsite, and P_{filled}, T_{filled}, P_{emptied}, and V_{emptied} are the pressures and volumes of the gas when fluid container 101 is delivered (filled) and picked up (emptied). Thus, by measuring the change in pressure of gas 113 with a known volume of liquid 115 in a fluid container 101 of known volume, the amount of liquid 115 dispensed may be calculated. In some embodiments, the temperature term may be ignored, assuming that gas 113 is air, and the temperature of the gas is the same as the temperature of the surrounding environment both when fluid container 101 is filled and when the measurement is taken.

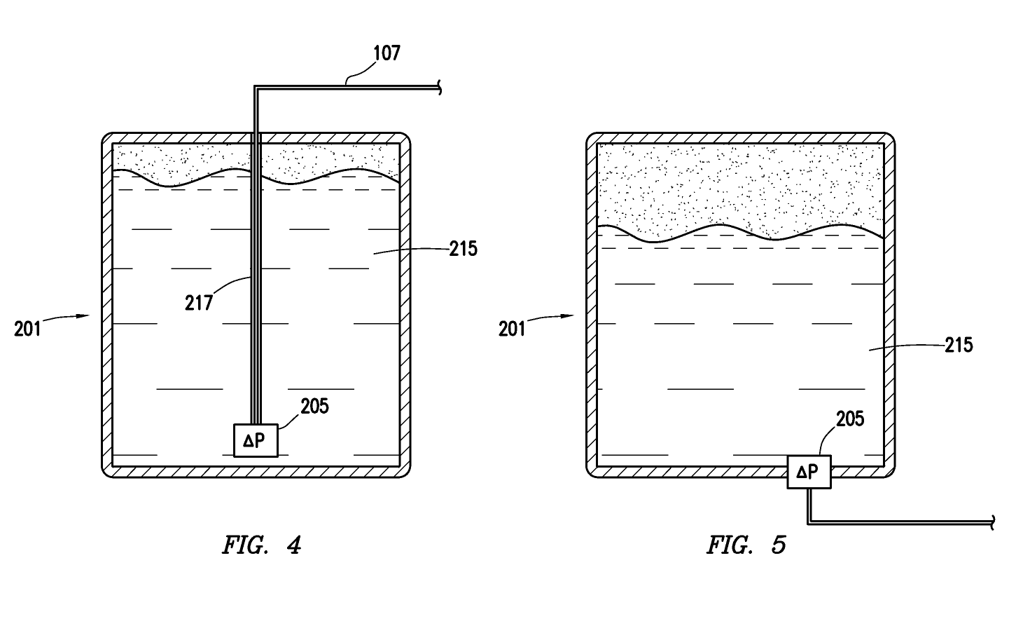

In some embodiments, the hydrostatic pressure of liquid within the container may instead be utilized. As depicted in FIG. 4, fluid container 201 may include hydrostatic pressure sensor 205 which is submerged within liquid 215. In some embodiments, hydrostatic pressure sensor 205 may be coupled to extension arm 217, extending from the top of fluid container 201. In some embodiments, extension arm 217 may be, for example, a wire or cable from which hydrostatic pressure sensor 205 is suspended. In some embodiments, hydrostatic pressure sensor 205 may include or be coupled to a weight to, for example, ensure hydrostatic pressure sensor 205 is able to sink to the bottom of any liquid 215 which may be in fluid container 201. In some embodiments, the weight distribution of hydrostatic pressure sensor 205 may be such that hydrostatic pressure sensor 205 lays horizontally on the bottom of fluid container 201. In other embodiments, as depicted in FIG. 5, fluid container 201 may include hydrostatic pressure sensor 205 which is mounted to the bottom of fluid container 201.

In embodiments measuring the hydrostatic pressure of liquid 215, the height of the column of liquid 215 may be calculated from the differential pressure measured by hydrostatic pressure sensor 205. Assuming that liquid 215 is incompressible, and thus the density of liquid 215 is constant, the height of liquid 215 above hydrostatic pressure sensor 205 may be calculated according to:

$$h = \frac{p}{g \cdot ρ} ,$$

where h is the height of liquid 215 above hydrostatic pressure sensor 205, p is the differential pressure measured by hydrostatic pressure sensor 205, g is the gravitational acceleration, and ρ is the density of the fluid. One having ordinary skill in the art with the benefit of this disclosure will understand that the density of liquid 215 may be calculated from its specific gravity, and that the density of liquid 215 may vary based on, for example, the temperature of liquid 215. By knowing the height of liquid 215 and the geometry of fluid container 201, the volume of liquid 215 in fluid container 201 may be calculated according to:

V=∫₀^{h}A(z)dz,

where V is the volume of liquid 215 above hydrostatic pressure sensor 205, z is a distance in the direction of h (up) from hydrostatic pressure sensor 205, and A(z) is the cross-sectional area of fluid container 201 at a distance z. By comparing the volume of liquid 215 measured at drop off and the volume of liquid 215 measured at pick-up, the volume of liquid 215 dispensed can be readily calculated.

With regards to FIG. 1, in some embodiments, control unit 111 may include a computer or microcontroller to make the relevant previously described calculations. In some embodiments, control unit 111 may further include equipment for transmitting the calculated volume change to portal 117 as depicted in FIG. 1. In some embodiments, control unit 111 may communicate by wireless communication equipment 119 to wireless communication equipment 121 at portal 117. In some embodiments, control unit 111 may communicate with portal 117 via satellite uplink 123 utilizing satellite 125. In some embodiments, satellite uplink 123 may be one of Globalstar or Iridium LEO networks. In some embodiments, control unit 111 may connect to a land-based communications network, such as cellular, GSM, LTE, HSPA, CDMA, etc. to communicate with portal 117. In some embodiments, control unit 111 may connect wirelessly to the internet to communicate its measurements to portal 117.

Once measurements are received at portal 117, portal 117 may initiate a billing request from the client. In some embodiments, each fluid container 101 may be assigned a unique identifier such as a serial number to allow portal 117 to associate the fluid container 101 with a specific client, worksite, liquid type, distributor, etc. Portal 117 may, in some embodiments, aggregate this data to identify the client, worksite, container, liquid type, distributor, and automatically generate a bill for the client based on the amount of liquid dispensed as calculated by control unit 111. In some embodiments, a user input on control unit 111 may cause control unit 111 to measure pressure differential and transmit the information to portal 117.

In other embodiments, rather than utilizing pressure sensor 105 to determine the amount of liquid dispensed from fluid container 101, a load cell may be used to determine the weight of fluid container 101, and thus derive the amount of liquid dispensed by comparing the weight of fluid container 101 at delivery and when picked up. Knowing the density or specific gravity of the liquid, the volume dispensed may be calculated. Such a load cell may be positioned on flatbed 10 or as a part of fluid container 101.

In still other embodiments, rather than utilizing pressure sensor 105 to determine the amount of liquid dispensed from fluid container 101, a distance sensor such as an ultrasonic, sonar, or radar unit may be used in conjunction with a strapping table for fluid container 101. As one of ordinary skill in the art will appreciate with the benefit of this disclosure, a strapping table is a tabular record of tank volume versus height so that taped, i.e., measurements of liquid depth can be converted into liquid volumes. The strapping table may be electronic or printed. In certain embodiments of the present disclosure, the strapping table may be contained in control unit 111 and, based on the measurement by the ultrasonic, sonar, or radar unit, determine the volume of liquid in fluid container 101. The ultrasonic, sonar, or radar unit may include a generator and a sensor. The generator may produce an ultrasonic, sonar, or radar signal. The ultrasonic, sonar or radar signal may rebound from the surface of the liquid and be captured by the sensor.

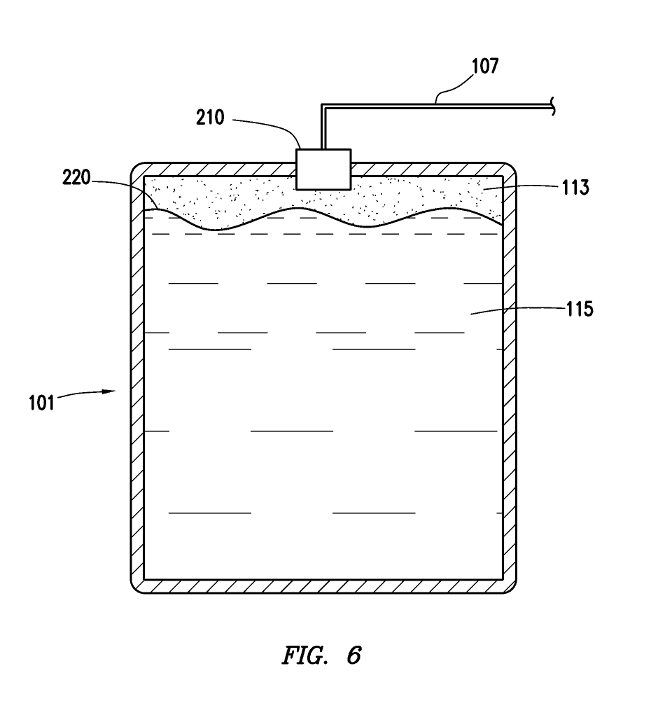

FIG. 6 depicts an embodiment of the present disclosure wherein an ultrasonic, sonar, or radar unit is used. Ultrasonic, sonar, or radar unit 210 may be inserted into fluid container 101 through a bung hole, washout cap, in an embodiment wherein, for instance, fluid container 101 is a tank truck or ISO container, or a dedicated port. The generator in ultrasonic, sonar, or radar unit 210 sends a signal that rebounds from fluid surface 220 to the sensor in ultrasonic, sonar, or radar unit 210. The sensor in ultrasonic, sonar or radar unit 210 may communicate with PLC 111 with an electrical signal via sensor wire 107. PLC 111 may then determine the distance between the sensor and fluid surface 220, the fluid level in fluid container 101, and, through use of the strapping table, the volume and/or mass of liquid in fluid container 101.

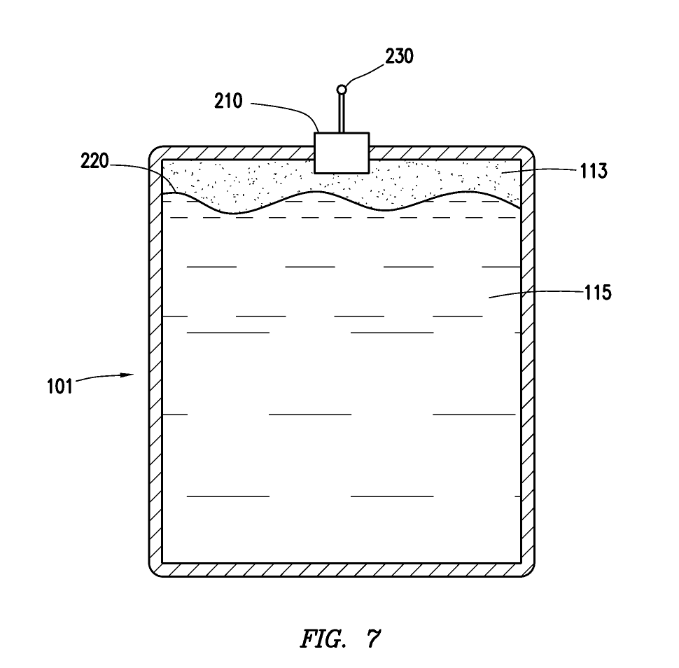

FIG. 7 depicts an embodiment of the present disclosure wherein ultrasonic, sonar, or radar unit 210 communicates wirelessly with PLC 111. As shown in FIG. 7, ultrasonic, sonar, or radar unit 210 further includes antenna 230. While antenna 230 is shown in FIG. 7. as external to ultrasonic, sonar, or radar unit 210, antenna 230 may also be within ultrasonic, sonar, or radar unit 210.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A system for determining the amount of liquid dispensed from a fluid container, the system comprising:
a fluid container, the fluid container having a top portion and the fluid container at least partially filled with a liquid, the fluid container including at least one drain outlet positioned to allow the liquid to be dispensed from the fluid container, the fluid container including a distance sensor being an ultrasonic, sonar or radar unit inserted through the top portion of the fluid container, the ultrasonic, sonar or radar unit comprising a generator and a sensor positioned to measure the distance from the top portion of the fluid container and the surface of the liquid;
a control unit positioned to receive a signal from the distance sensor and positioned to calculate the volume of liquid dispensed.

2. The system of claim 1, further comprising a flatbed truck, the fluid container positionable on the flatbed truck, the control unit positioned on the flatbed truck, the flatbed truck including a sensor bus positioned to electrically connect the distance sensor to the control unit.

3. The system of claim 2, wherein the sensor bus is positioned on the side of the flatbed truck.

4. The system of claim 1, wherein the control unit further comprises a transmitter, the transmitter positioned to transmit the calculated volume of liquid dispensed to a receiver positioned on a portal.

5. The system of claim 4, wherein the fluid container is assigned a unique identifier, the unique identifier allowing the portal to associate the fluid container with a client.

6. The system of claim 5, wherein the portal automatically generates an invoice for the client based on the amount of liquid dispensed.

7. The system of claim 4, wherein the transmitter transmits electromagnetic signals to the receiver via a satellite connection.

8. A method of measuring a volume of a liquid dispensed, the method comprising:
filling, at least partially, a fluid container with a liquid, the remainder of the interior of the fluid container filled with a gas, the fluid container including at least one drain outlet positioned to allow the liquid to be dispensed from the fluid container, the fluid container including a distance sensor being an ultrasonic, sonar or radar unit inserted through the top portion of the fluid container, the ultrasonic, sonar or radar unit comprising a generator and a sensor positioned to measure the distance from the top portion of the fluid container and the surface of the liquid;
calculating an initial volume of liquid in the fluid container using at least a first distance measurement from the distance sensor;
dispensing at least a portion of the liquid from the fluid container;
calculating a second volume of liquid in the fluid container using at least a second distance measurement from the distance sensor; and
calculating the volume of liquid dispensed.

9. The method of claim 8, further comprising coupling the distance sensor to a control unit, wherein the calculating operations are carried out by the control unit.

10. The method of claim 9, wherein the control unit is positioned on a flatbed truck, and the distance sensor is coupled to the control unit via a sensor bus.

11. The method of claim 9, wherein the control unit further includes a transmitter positioned to transmit the volume of liquid dispensed to a receiver positioned on a portal.

12. The method of claim 11, wherein the control unit transmits to the receiver via a wireless interface.

13. The method of claim 12, wherein the wireless interface is a satellite connection.

14. The method of claim 8, further comprising:
assigning a unique identifier to the fluid container;
associating the unique identifier with a client and liquid type;
generating an invoice for the client based on the type of liquid and volume of liquid dispensed.

15. The system of claim 1, wherein the control unit calculates the volume of liquid dispensed in conjunction with a strapping table.

16. The system of claim 1, wherein the fluid container is a tank truck, ISO container, frac tank, or compartment of a multi-compartment tank.

17. The system of claim 1, wherein the distance sensor further comprises a transmitter adapted to transmit the signal to a receiver of the control unit wirelessly.

18. The system of claim 1, wherein the distance sensor sends the signal to the control unit by one or more sensor wires.

19. The system of claim 1, further comprising a flow meter attached to the drain outlet adapted to determine the amount of fluid exiting the drain outlet.

20. The method of claim 11, further comprising:
receiving by the control unit a signal corresponding to the distance between the top portion of the fluid container and the surface of the liquid; and
calculating the volume of fluid in the fluid container in conjunction with a strapping table.

21. The method of claim 8, wherein the fluid container is a tank truck, ISO container, frac tank, or compartment of a multi-compartment tank.

22. The method of claim 20, wherein the distance sensor sends the signal to the control unit by one or more sensor wires.

23. The method of claim 20, wherein the distance sensor further comprises a transmitter adapted to transmit the signal to a receiver of the control unit wirelessly.

24. The method of claim 8, further comprising a flow meter attached to the drain outlet adapted to determine the amount of fluid exiting the drain outlet.
